(19) United States
(12) Patent Application Publication
(10) Pub. No.: US 2022/0108354 A1
(43) Pub. Date: Apr. 7, 2022

(54) AUTONOMOUS SYSTEM AND METHOD OF COMBINING OF DIGITAL SIGNAGE AND MOBILE MEDIA CONTENT

(71) Applicant: Moving Walls Pte Ltd, Singapore (SG)

(72) Inventor: Srikanth RAMACHANDRAN, Kuala Lumpur (MY)

(21) Appl. No.: 17/495,724

(22) Filed: Oct. 6, 2021

Related U.S. Application Data
(60) Provisional application No. 63/088,834, filed on Oct. 7, 2020.

(51) Int. Cl. G06Q 30/02

(52) U.S. Cl. CPC G06Q 30/0267; G06Q 30/0244; G06Q 30/0261; G06Q 30/0271

(57) ABSTRACT

A method for optimizing media content to be displayed across a network of DOOH advertising media and digital advertisements. The method includes dispersing sensors at locations for characterizing viewers of the media and advertisements at that location, receiving information from each device detected at each location in a database. Parameters are processed including age, gender, affinity, location, number of viewers, frequency of exposing viewers, and proportion of viewers to be targeted by specific advertisements. A model created by using prior collected information from other advertising campaigns, and from at least one sensor dispersed in at least one additional location. The model determines a list of new locations for the advertiser to target. Media content is displayed at the new location and mobile advertisements are displayed for each device. A set of locations where the advertisement will next be displayed and mobile devices are determined to be targeted. An apparatus that utilizes the method is also provided.

### BACKGROUND OF THE INVENTION

The present invention is directed to digital signage. More particularly, the present invention is directed to digital signage media networks.

Digital Out-Of-Home (DOOH) advertising is becoming increasingly popular as compared with conventional techniques of branding, such as the use of television advertisements, radio advertisements, billboards and signages. DOOH is a form of advertising which involves displaying digital promotional content on digital media assets such as LED screens at indoor or outdoor locations for communicating with audiences/viewers in public places such as popular streets, shopping malls, cafes, shops, transportation hubs, gasoline stations and similar locations.

Typically, the LED screens or “digital media assets” as they are commonly known are located at various indoor or outdoor locations where they could catch the eye of on-the-go consumers while they are outside their home or offices. These digital media assets are typically rented by companies or individuals for advertising their products and/or services.

Currently, as an enhancement to a DOOH campaign, an advertiser may choose to collect mobile user information of those near digital screens and retarget these users with additional mobile advertisements. This retargeting of users across DOOH networks and mobile devices can improve advertising campaign efficiency and engagement, but the retargeting by itself does not allow for an integrated campaign that can address an advertiser's needs to optimally expose advertising content to users.

In general, for all advertisement campaigns, the advertiser generally follows three steps:
Target Segment Selection—The advertiser selects a target segment to reach based on demographics and behavior data.
Reach Target Segments—The advertiser triggers a campaign to reach this target segment that will include selecting content for the campaign and other operational parameters for the campaign.

Attribution Modelling or Measurement—The advertiser determines the effectiveness of this campaign using an attribution mechanism (click through, visit to store, app download, etc.).

### SUMMARY OF THE INVENTION

In a first exemplary embodiment of the present invention, a method for optimizing media content to be displayed across a network of DOOH advertising media and digital advertisements displayed to a set of mobile devices based on parameters relevant to running an advertising campaign is provided. The method first includes the step of dispersing at least one sensor at each of at least one location, the sensors for fetching information for characterizing viewers of the DOOH advertising media and digital advertisements at that location. The method continues with the step of receiving information from each device of the set of mobile devices detected at each location in a database that stores an identification for each of the set of mobile devices and data showing at least two of the time of detection, website accesses detected at the location, device identification, and a timestamp for each website access. The parameters are then processed including age, gender, affinity, location, total number of viewers to be targeted, frequency of exposing targeted viewers, and/or proportion of viewers to be targeted by specific advertisements on mobile devices. Information from each device of the set of mobile devices is processed to determine a model created by using prior collected information from at least one other advertising campaign. Information is processed from at least one sensor dispersed in at least one additional location wherein the model determines an initial list of new locations for the advertiser to target with DOOH content and a list of device identifications to target. Media content is displayed at the at least one new location and/or mobile advertisements for each device identification as specified by the model are displayed. A set of locations of the plurality of locations where the advertisement will next be displayed is determined. A set of mobile devices to be targeted by mobile advertisements is also determined.

The network may include DOOH advertising media including digital signage. The steps of processing the parameters through determining a set of locations where the advertisement will next be displayed and determining a set of mobile devices to be targeted by mobile advertisements may be iterated until a desired outcome for the advertising campaign is achieved. The step of dispersing the sensors may include dispersing sensors such as eye trackers, Bluetooth-based sensors, Wi-Fi-based sensors, traffic sensors, weather sensors, social media sensors, telco sensors, mobile app-based sensors, video camera-based sensors, and combinations thereof. The step of processing the parameters may include processing parameters that are specified for each location. The steps of recording the viewers and identifying at least one of size, gender, age, and affinity of the viewers to be used in the step of processing the parameters may also be included.

In another exemplary embodiment of the present invention, a system for optimizing media content to be displayed across a network of digital signage and/or DOOH advertising media and digital advertisements displayed to a set of mobile devices based on parameters relevant to running an advertising campaign is also provided. The system includes sensors dispersed in a geographical location, where the sensors fetch information characterizing viewers of the digital signage and or DOOH advertising media and digital advertisements at the location. One or more databases containing information on mobile devices detected at a particular geographical location are provided, wherein the databases store an identification as a representation of the device and a timestamp showing at least two of the time of detection, website accesses detected at the location, device identification, and a timestamp for each website access. A processor for receiving the parameters is provided wherein the parameters include, for example, gender, affinity, location, total number of viewers to be targeted, frequency of exposing targeted viewers, and proportion of viewers to be targeted by specific advertisements on mobile devices. The processor processes the information in the database to determine a model created using prior collected information from at least one other advertising campaign. The processor also processes information in the database from a plurality of sensors dispersed in at least one additional geographical location wherein the model determines an initial list of additional locations for the advertiser to target with DOOH content and a list of device identifications to target for mobile content. ++ The processor causes the digital signage and DOOH advertising media and digital advertisements display to display the media content at the additional locations and/or for display of mobile advertisements for the device identifications. ++ The processor causes at least one of (i) the digital signage and DOOH advertising media, and (ii) digital advertisements to be displayed to a set of mobile devices, to display the media content at the additional locations.

The sensors may include eye trackers, Bluetooth-based sensors, Wi-Fi based sensors, traffic sensors, weather sensors, social media sensors, telco sensors, mobile app-based sensors, video camera-based sensors, and combinations thereof. The parameters may be specified based on the location. A recording device at the locations where an advertisement is shown may record the viewers that were exposed to the advertisement and identify at least one of size, gender, age, and affinity of the viewers.

### BRIEF DESCRIPTION OF THE DRAWINGS

FIG. 1 depicts a flowchart of a method for optimizing media content to be displayed across a network of DOOH advertising media and digital advertisements displayed to a set of mobile devices based on parameters relevant to running an advertising campaign in accordance with an exemplary embodiment of the present invention.

FIG. 2 depicts a simplified schematic diagram of a system for optimizing content to be displayed across a network of digital signage and/or DOOH advertising media and digital advertisements displayed to a set of mobile devices based on parameters specified by an advertiser in accordance with an exemplary embodiment of the present invention that utilizes the method of FIG. 1.

### DETAILED DESCRIPTION OF THE PREFERRED EMBODIMENT

The present invention is directed DOOH/Digital Signage media networks. It relates to a system and method for achieving an optimal combination of content to be displayed across a network of digital screens (digital signage and/or DOOH advertising media) and digital advertisements displayed to a set of mobile devices based on parameters specified by advertisers that are used to satisfy the goals of a campaign.

The present invention uses sequencing of advertisements across mobile devices and DOOH screens to reach audiences/viewers in order to achieve optimal exposure of an advertising brand to the audience/viewers. It is also possible to use this technique to achieve a desired target exposure specified by the outcome goals of the advertising campaign. The results from a particular sequence of advertisements to mobile devices and a set of DOOH screens are monitored based on the advertiser's attribution model. An attribution model may consist of visits and sales conversion information derived from, for example, an advertiser's website, a retail store, or by total sales at a location. These results from the attribution model are processed using a machine learning algorithm to determine efficacy of an advertising campaign at the DOOH network locations and with the specific sequence of media content and mobile advertisements. The output of the learning algorithm is then used to program the sequence of consumer engagement in the software to produce better results in future campaigns. This results in a continuous learning process whereby outcomes are improved and an optimal advertising campaign can be delivered.

In general, advertisers currently may have several potential goals for such campaigns that are outlined below:

Incremental Reach—An advertiser could have a physical presence through a retail outlet (e.g., bank branch) that has digital screens. The objectives of the DOOH+ mobile campaign may be to capture audiences/viewers who are not likely to be exposed to the screens at a retail outlet and target them.

Substitute Reach—An advertiser may want to display their advertisements on screens at selected locations. However, budgets or media availability may restrict the ability to achieve this goal. The objective of the DOOH plus mobile media campaign may be to target mobile users only at locations where the advertisers are not able to find screens to display DOOH media content.

Incremental Frequency—An advertiser may want to reinforce the advertising content presented on a DOOH screen. The objective of the DOOH plus mobile media campaign may be to target mobile users that have had the opportunity to see the advertising content on a screen to reach the same audiences/viewers again and reinforce the advertising message.

In all of these scenarios, machine learning algorithms can be used to achieve better outcomes. By feeding results from campaign strategies that use each of these goals to a learning process, a specific strategy can be determined that leads to the best campaign for an advertiser. The learning process will determine the best set of DOOH and mobile media actions that will ensure the highest probability for a target audience/viewers to take a desired action.

Some possible input variables that may be considered by the algorithm include:
Media Exposure—Frequency and sequencing of events across DOOH and Mobile media
Media Impact—Size, shape and location of the DOOH screen and location of mobile media targets.
Media Exposure—Certain locations could be prone to clutter because of excessive screens in the area or because screens display competitor brands.
Creatives category—Choice of creative used in the communication (assuming there are multiple creative options) that are enumerated in categories.
Measurement Attribute—The desired outcome to be measured may be an advertisement click, website visit, content download or other similar actions. This could be a target to achieve or a quantity to maximize.

The present invention is directed to a system and method that enables advertising campaigns that can target a mixture of DOOH media assets and mobile devices based on a set of parameters provided by an advertiser which are then enhanced using a machine learning model to optimize the desired results. The model learns continuously during the campaign and makes media decisions for DOOH and Mobile media that determines which location to target for this audience/viewers, the timing of advertisement buys and the content to serve at each time. These decisions are dynamically made to maximize the desired outcome or to achieve a certain outcome level.

Embodiments of the present invention provide a system and method to conduct a DOOH media network campaign in coordination with content on other media assets types such as mobile devices and e-commerce websites to achieve optimal results based on an attribution model.

The proposed system comprises a plurality of sensors which are dispersed in a particular geographical location to fetch information characterizing the DOOH audience/viewers at that location. Typically, the sensors include eye trackers, Bluetooth based sensors, WiFi based sensors, traffic sensors, weather sensors, social media sensors, telco sensors, mobile app-based sensors, video camera-based sensors, and combinations thereof. In addition to the sensors, the system comprises a database or databases containing information on mobile devices detected at a particular geographical location using an identification as a representation of the device and a timestamp showing the time of detection, information on website accesses detected at locations which may be stored along with the device identifications (IDs) and timestamps of these accesses.

When a combined DOOH campaign and mobile campaign is initiated by an advertiser, outcome parameters relevant to running the campaign are specified for the campaign. As an illustration, these parameters can include the type of audience/viewers the advertiser is attempting to reach such as age, gender, affinity, location and other well-known audience/viewer characteristics used in the industry. The advertiser may also specify any of the following additional parameters: the total number of viewers (or impressions) to be targeted by the campaign, the frequency of exposing the targeted viewers, the proportion of these viewers that are to be targeted by specific advertisements (chosen by the advertiser or by an algorithm) on mobile devices which may include specific device IDs to be targeted, the proportion of these viewers that are to be targeted by specific advertisements (chosen by the advertiser or by an algorithm) at a website specified either by its the URL location or by an affinity list specified by the advertiser and the frequency capping of an advertisement. In addition, each of these parameters can be specified for any given location in the campaign. The advertiser may also provide parameters for the campaign that are more common in traditional digital advertising such as a targeted number of clicks to one or several website pages, a targeted number of conversions (such as a sale or a request for information) or a combination of these parameters.

Given these parameters for a combined DOOH campaign and mobile campaign, one embodiment of the system processes the information retrieved from sensors and the information collected from the database of device IDs along with the parameters provided by an advertiser to determine a model (generally created using prior learnt information from other campaigns) for the campaign. Using the audience/viewer information associated with different locations and the database of mobile device IDs along with the media provided by an advertiser, the model determines an initial list of locations for the advertiser to target with its DOOH content and a list of device IDs to target for its mobile content.

The system will then execute the programming steps for displaying this initial set of media content at the given DOOH locations and for displaying mobile advertisements for the device IDs specified by the model. This may include requesting ads slots for these devices through a bidding auction or through agreements with ad publishers. While these actions are performed, sensors at the chosen DOOH locations where an advertisement is shown record the audience/viewer that was exposed to the advertisement including the size of the audience/viewer and its characteristics such as gender, age and affinity. The system will also measure the number of user interactions, such as clicks or conversions, for each advertisement shown on mobile devices near the DOOH screens and for mobile devices that had campaign ads displayed on these devices.

Using these measured user interaction parameters and based on the advertisers desired outcome for user interaction, the learning algorithm will update the set of DOOH locations where the advertisement will next be displayed and also update the set of mobile devices (specified by their device IDs) targeted by the campaigns mobile advertisements. The learning algorithm may use several parameters of the campaign to update the DOOH locations and the mobile devices including the relative interaction rates between targeted mobile devices near the DOOH locations where campaign ads are displayed vs. those devices that were not near these locations, the number of times a mobile device has been seen near the DOOH locations targeted by the campaign, and the relative audience/viewer measurements at different locations as some examples.

This iteration of the next DOOH locations and new mobile devices to target will continue until the advertisers desired campaign outcome is achieved. There could be one of several criteria for the end of a campaign including a specified time period, a specified number of user interactions, a specified number of impressions delivered to either mobile devices or to an audience/viewer.

The learning algorithm and associated Machine Learning model could be one of several algorithms based on the needs of the system. One example of this could be as follows:

Based on previous campaigns, a Machine Learning model is created which specifies a specified initial sequence of DOOH ads and mobile ads to be played across locations and devices. This may, for example, be where DOOH ads are first displayed in a small area for a particular number of days followed by the display of mobile ads to devices in the same area and where this cycle is repeated for several weeks in each model with a differing number of days for display of each.

The model will determine this sequence by maximizing the desired outcome using a machine learning technique such as logistical regression, random forest or another form of regression based on the input parameters of the model which may include factors such as the money invested into the campaign, the geographical location of the campaign and the type of audiences/viewers that is desired to reach for the campaign. The outcomes of the campaign, as explained above, may comprise a certain number of clicks, mobile app opens or website visits that the advertiser may be targeting.

On the start of a campaign, the model chooses an initial sequence of DOOH locations and mobile devices to target with ads. In the execution of this initial sequence, the system measures the outcome parameters such as exposed audience/viewers, the number of clicks or mobile app opens.

This measured outcome is fed back to the machine learning model. This will then modify the desired outcome based on the initial requirement and this updated measured information. The new desired outcome will then be run through the same or another machine learning algorithm (such as logistical regression, random forest or other algorithm) to determine the next sequence of ads to be played at DOOH locations and mobile ads to be displayed on devices. This is repeated until the initial desired outcome is reached.

Note that there are several variations of these steps possible. Instead of reaching a desired outcome a campaign may want maximization of a particular parameter. The model will be suitably modified for these cases.

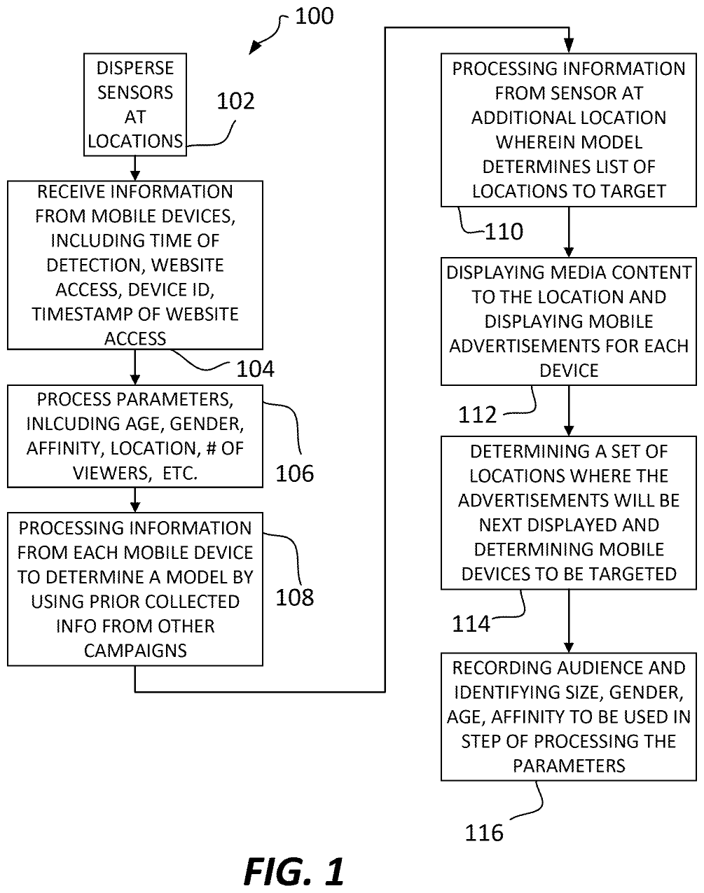

Referring now to the drawing figures wherein like reference numbers refer to like elements throughout the several views, there is shown in FIG. 1 a flowchart of a method 100 for optimizing media content to be displayed across a network of DOOH advertising media and digital advertisements displayed to a set of mobile devices based on parameters relevant to running an advertising campaign. The method begins with the step of dispersing at least one sensor at each of at least one location 102. The sensors are for fetching information for characterizing viewers of the DOOH advertising media and digital advertisements at that location. The method continues with the step of receiving information from each device of the set of mobile devices detected at each location in a database that stores an identification for each of the mobile devices and data showing, for example, the time of detection, website accesses detected at the location, device identification, and a timestamp for each website access 104. Preferably, at least two of these are stored.

The method continues with the steps of processing the parameters including, for example, age, gender, affinity, location, total number of viewers to be targeted, frequency of exposing targeted viewers, and/or proportion of viewers to be targeted by specific advertisements on mobile devices 106; processing the information from each device of the set of mobile devices to determine a model created by using prior collected information from at least one other advertising campaign 108; and processing information from at least one sensor dispersed in at least one additional location wherein the model determines an initial list of new locations for the advertiser to target with DOOH content and a list of device identifications to target 110.

Finally, the method continues with the steps of displaying media content at the at least one new location and displaying mobile advertisements for each device identification as specified by the model 112, and determining a set of locations of the plurality of locations where the advertisement will next be displayed and determining a set of mobile devices to be targeted by mobile advertisements 114. The step of processing the parameters 106 through the step of determining a set of mobile devices to be targeted through mobile advertisements 114 may be iterated until a desired outcome for the advertising campaign is achieved.

The network including DOOH advertising media may include digital signage. The step of dispersing the sensors may include sensors such as eye trackers, Bluetooth-based sensors, Wi-Fi-based sensors, traffic sensors, weather sensors, social media sensors, telco sensors, mobile app-based sensors, video camera-based sensors, and combinations thereof. The step of processing the parameters includes processing parameters that are specified for each location. The step of recording 116 the viewers and identifying at least one of size, gender, age, and affinity of the viewers to be used in the step of processing the parameters may also be included.

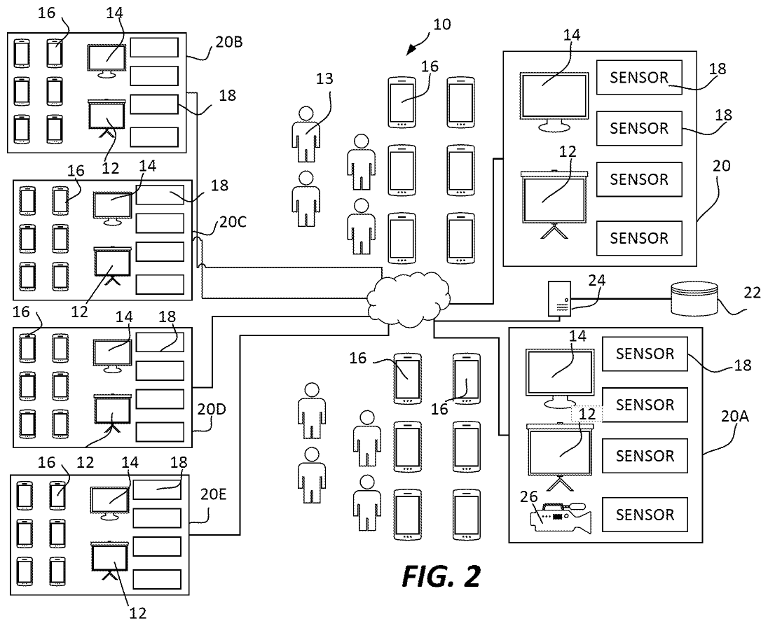

As can be seen in FIG. 2, the present invention is also directed to a system 10 for optimizing media content to be displayed across a network of digital signage 12 and/or DOOH advertising media 14 and digital advertisements displayed to a set of mobile devices 16 based on parameters relevant to running an advertising campaign. The system 10 includes two or more sensors 18 dispersed in a geographical location 20. The sensors 18 fetch information characterizing viewers 13 of the digital signage 12 and or DOOH advertising media 14 and digital advertisements at the location 20.

At least one database 22 contains information on mobile devices 16 detected at a particular geographical location. The database 11 stores an identification as a representation of the mobile 16 device and a timestamp showing at least two of: the time of detection; website accesses detected at the location; mobile device identification; and a timestamp for each website access. A processor 24 receives the parameters. The parameters may include age, gender, affinity, location, total number of viewers 13 to be targeted, frequency of exposing targeted viewers, proportion of viewers 13 to be targeted by specific advertisements on mobile devices, and the like.

The processor 24 processes the information in the database 22 to determine a model created using prior collected information from at least one other advertising campaign. The processor 24 processes information in the database 22 from sensors 18 dispersed in at least one additional geographical location 20A wherein the model determines an initial list of additional locations 20B, 20C, 20D . . . for the advertiser to target with DOOH content and a list of device identifications to target for mobile content. The processor 24 causes the digital signage and DOOH advertising media and digital advertisements display to display the media content at the additional locations and for display of mobile advertisements for the device identifications.

The sensors 18 may include, for example, eye trackers, Bluetooth-based sensors, Wi-Fi-based sensors, traffic sensors, weather sensors, social media sensors, telco sensors, mobile app-based sensors, video camera-based sensors, and combinations thereof. The parameters may be specified based on the location. A recording device 26 at the locations where an advertisement is shown may record the viewers 13 that was exposed to the advertisement and identify at least one of size, gender, age, and affinity of the viewers 13.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method for optimizing media content to be displayed across a network of digital out-of-home (DOOH) advertising media and digital advertisements displayed to a set of mobile devices based on parameters relevant to running an advertising campaign, comprising the steps of:
(a) dispersing at least one sensor at each of at least one location, said at least one sensor at each location for fetching information for characterizing viewers of the DOOH advertising media and digital advertisements at that location;
(b) receiving information from each device of the set of mobile devices detected at each location in a database that stores an identification for each of the set of mobile devices and data showing at least two of:
(i) the time of detection;
(ii) website accesses detected at the location;
(iii) device identification; and
(iv) a timestamp for each website access;
(c) processing the parameters wherein the parameters are selected from the group consisting of age, gender, affinity, location, total number of viewers to be targeted, frequency of exposing targeted viewers, and proportion of viewers to be targeted by specific advertisements on mobile devices.
(d) processing the information from each device of the set of mobile devices to determine a model created by using prior collected information from at least one other advertising campaign;
(e) processing the information from at least one sensor dispersed in at least one additional location wherein the model determines an initial list of new locations for the advertiser to target with DOOH content and a list of device identifications to target;
(f) at least one of (i) displaying media content at the at least one new location and (ii) displaying mobile advertisements for each device identification as specified by the model;
(g) determining a set of locations of the plurality of locations where the advertisement will next be displayed and determining a set of mobile devices to be targeted by mobile advertisements.

2. The method of claim 1, wherein the network including DOOH advertising media includes digital signage.

3. The method of claim 1, including iterating steps (c) through (g) until a desired outcome for the advertising campaign is achieved.

4. The method of claim 1, wherein the step of dispersing the sensors includes dispersing sensors selected from the group consisting of eye trackers, Bluetooth-based sensors, Wi-Fi-based sensors, traffic sensors, weather sensors, social media sensors, telco sensors, mobile app-based sensors, video camera-based sensors, and combinations thereof.

5. The method of claim 1, wherein the step of processing the parameters includes processing parameters that are specified for each location.

6. The method of claim 1, including the steps of recording the viewers and identifying at least one of size, gender, age, and affinity of the viewers to be used in the step of processing the parameters.

7. A system for optimizing media content to be displayed across a network of digital signage and/or digital out-of-home (DOOH) advertising media and digital advertisements displayed to a set of mobile devices based on parameters relevant to running an advertising campaign, comprising:
(a) a plurality of sensors dispersed in a geographical location, said sensors adapted to fetch information characterizing viewers of the digital signage and or DOOH advertising media and digital advertisements at the location;
(b) at least one database containing information on mobile devices detected at a particular geographical location, wherein the database stores an identification as a representation of the device and a timestamp showing at least two of:
(i) the time of detection;
(ii) website accesses detected at the location;
(iii) device identification; and
(iv) a timestamp for each website access;
(c) a processor for receiving the parameters, wherein the parameters include parameters selected from the group consisting of age, gender, affinity, and location, total number of viewers to be targeted, frequency of exposing targeted viewers, proportion of viewers to be targeted by specific advertisements on mobile devices;
(d) wherein the processor is adapted to process the information in the database to determine a model created using prior collected information from at least one other advertising campaign;
(e) wherein the processor is adopted to process information in the database from a plurality of sensors dispersed in at least one additional geographical location wherein the model determines an initial list of additional locations for the advertiser to target with DOOH content and a list of device identifications to target for mobile content;
(f) wherein the processor is adapted to cause at least one of:
(i) the digital signage and DOOH advertising media, and
(ii) digital advertisements displayed to a set of mobile devices;
to display the media content at the additional locations.

8. The system of claim 7, wherein the sensors include sensors selected from the group consisting of eye trackers, Bluetooth-based sensors, Wi-Fi-based sensors, traffic sensors, weather sensors, social media sensors, telco sensors, mobile app-based sensors, video camera-based sensors, and combinations thereof.

9. The system of claim 7, wherein the parameters are specified based on the location.

10. The system of claim 7, wherein a recording device at the locations where an advertisement is shown is adapted to record the viewers that were exposed to the advertisement and identify at least one of size, gender, age, and affinity of the viewers.
